(19) United States
(12) Patent Application Publication
(10) Pub. No.: US 2004/0250859 A1
(43) Pub. Date: Dec. 16, 2004

(54) Method for protecting a pneumatic control system from ingested contamination

(76) Inventors: James M. Poulin, Derry, NH (US); William Clark, Hampstead, NH (US)

Correspondence Address: McDermot, Will & Emery, 28 State Street, Boston, MA, 02109, US

(21) Appl. No.: 10/460,110

(22) Filed: Jun. 12, 2003

(51) Int. Cl. F16K 37/00

(52) U.S. Cl. 137/559

(57) ABSTRACT

A pneumatic control system including at least one flow control line having a connecting line connectable to a fluid line of a pneumatically operated machine, a vacuum line connectable to a vacuum source, a vacuum valve controlling flow between the connecting line and the vacuum line, a pressure line connectable to a source of fluid under pressure, and a pressure valve controlling flow between the connecting line and the pressure line. A pressure manifold defines the pressure line and a first portion of the connection line, and supports the pressure valve, and a vacuum manifold defines the vacuum line and a second portion of the connecting line, and supports the vacuum valve. The vacuum manifold is adapted for replacement independently of the pressure manifold.

### FIELD OF THE DISCLOSURE

The present disclosure relates generally to pneumatic control systems and more specifically to a pneumatic control system for pressurizing and evacuating semiconductor processing equipment. More particularly, the present disclosure relates to a method for protecting a pneumatic control system from vacuum contaminants.

### BACKGROUND OF THE DISCLOSURE

Integrated circuits are typically formed on substrates, particularly silicon wafers, by the sequential deposition of conductive, semiconductive or insulative layers. After each layer is deposited, the layer is etched to create circuitry features. As a series of layers are sequentially deposited and etched, the outer or uppermost surface of the substrate, i.e., the exposed surface of the substrate, becomes increasingly non-planar. This non-planar surface presents problems in the photolithographic steps of the integrated circuit fabrication process. Therefore, there is a need to periodically planarize the substrate surface.

Chemical mechanical polishing (CMP) is one accepted method of planarization. This planarization method typically requires that the substrate be mounted on a carrier or polishing head. The exposed surface of the substrate is placed against a rotating polishing pad. The carrier head provides a controllable load, i.e., pressure, on the substrate to push it against the polishing pad. A polishing slurry, including at least one chemically-reactive agent and, in some cases, abrasive particles, is supplied to the surface of the polishing pad.

FIG. 1 shows a simplified drawing of an example of a CMP carrier head system 10 according to the prior art. The carrier head system 10 independently rotates about its own axis, and has a carrier drive shaft 12 connecting a rotation motor 14 to a carrier head 16. A rotary coupling 18 at the top of the drive motor 14 couples three fluid lines 20a-20c to channels 22a-22c in the drive shaft 12, which are in turn connected to internal chambers (not shown) of the carrier head 16. As is known, the internal chambers of the carrier head 16 are formed at least in part by resilient bladders which expand upon the chambers being pressurized and which contract upon a vacuum being created within the chambers. For example, pressurizing a chamber in the carrier head 16 can be used to press a substrate against a rotating polishing pad, while creating a vacuum in the chamber can be used to provide suction for holding the substrate against the carrier head 16 during transfer of the substrate to and from the polishing pad.

A pneumatic control system 30, which can include pressure sensors, and controllable valves, connects the fluid lines 20a-20c extending from the rotary coupling 18 to a vacuum source 32 and a pressure source 34. The pneumatic control system 30 is appropriately connected to a computer 36, which is programmed to operate the controllable valves to alternatively connect the chambers of the carrier head 16 to the vacuum source 32 and the pressure source 34 and, thus, pneumatically power the carrier head 16. In the exemplary CMP carrier head system 10 of FIG. 1, the system 10 includes three fluid lines (e.g., an external chamber, an internal chamber and a retaining ring) 20a-20c. However, the CMP carrier head system 10 can be provided with less than three or more than three fluid lines 20a-20c as necessary and as depending on the number of chambers provided in the carrier head 16.

FIG. 2 shows an example of the components of the pneumatic control system 30, which is constructed according to the prior art. The system 30 generally includes three flow control lines 40a-40c connected respectively to the three fluid lines 20a-20c of the rotary coupling 18 of the CMP carrier head system 10. Of course, the system 30 can include more or less than three flow control lines 40a-40c depending upon the number of fluid lines 20a-20c contained in the CMP carrier head system 10.

The system 30 also includes a single manifold 38 containing all portions of the three flow control lines 40a-40c. Each flow control line 40a-40c includes a connecting line 42 extending from the fluid lines 20a-20c of the rotary coupling 18 of the CMP carrier head system 10, and at least one “connecting” valve 44 (e.g., a direct operated-type valve) alternatively connecting the connecting line 42 to a vacuum line 46 or a pressure line 48. The three flow control lines 40a-40c can also include a second vent line 58 connected to the connecting line 42 through a vent valve 60, so that the connecting line 42 can also be vented to atmosphere.

As their names imply, the vacuum lines 46 are connected to the at least one vacuum source 32, shown in FIG. 1, so that, when the connecting valves 44 connect the connecting lines 42 to the vacuum lines 46, a vacuum is created in the respective fluid line 20a-20c of the rotary coupling 18 of the CMP carrier head system 10. Each pressure line 48 includes a “pressure” valve 50 (e.g., a proportional-type valve) and is connected to at least one source 34, as shown in FIG. 1, of pressured gas (e.g., air or nitrogen). Each pressure line 48 also includes a bleed valve 54. The bleed valve 54 is connected to a bleed line 52 and a bleed flow restrictor 56. The bleed valve 54 and pressure valve 50 work in tandem. When both are opened a flow is created from the pressure source 34, through the pressure valve 50, the bleed valve 54, the bleed line 52 and out through the flow restrictor 56. The pressure valve 50 (e.g., a proportional-type valve) can be varied between open and close to control this flow. When the connecting valve 44 connects the connecting line 42 to the pressure line 48 a controlled flow of gas is now connected to the respective fluid line 20a-20c of the rotary union coupling 18 of the CMP carrier head system 10.

All of the flow control lines 40a-40c include a first pressure transducer 62 in the connecting line 42. All of the valves 44, 50, 54, 60 shown in FIG. 2 are connected to the computer 36 shown FIG. 1, so that the computer 36 controls operation of the valves. All of the pressure transducers 62 shown in FIG. 2 are connected to the computer 36 shown FIG. 1, so that the pressure transducers provide pressure measurements to the computer 36.

One problem associated with the pneumatic control system 10 of the prior art occurs when a vacuum is being created within the carrier head 16 during a CMP procedure, and a bladder in the carrier head 16 fails. When the bladder fails, the polishing slurry used as part of the CMP procedure is sucked into the pneumatic control system 30. Before the carrier head 16 can be used again, the bladder must be replaced, the pneumatic control system 30 contaminated with the polishing slurry must be replaced and the new pneumatic control system 30 must be recalibrated. A bladder failure and subsequent replacement and recalibration of the pneumatic control system 30, in turn, can lead to a long downtime for the CMP carrier head system 10.

In an effort to protect against surry contamination of the pneumatic control system 10 during a bladder failure, some pneumatic control systems have been provided with in line filters for preventing the slurry from reaching the pneumatic control systems upon a bladder failure. However, such filters have been found to reduce the response time and the evacuation time of the pneumatic control system 10. In addition, the filters can become plugged over time to thereby reduce or eliminate the vacuum(s) created by the system 10 to cause the carrier head 16 to hold a substrate during transfer of the substrate to and from the polishing pad. When the vacuums are reduced or eliminated the substrate can be dropped and damaged or destroyed.

What is still desired, therefore, is a new and improved pneumatic control system, which can be used for, but is not limited to, pressurizing and evacuating semiconductor processing equipment, such as a CMP carrier head system for example. Preferably, the new and improved pneumatic control system will include an apparatus and method for protecting the pneumatic control system from vacuum contaminants.

### SUMMARY OF THE DISCLOSURE

The present disclosure provides a pneumatic control system including at least one flow control line having a connecting line connectable to a fluid line of a pneumatically operated machine, a vacuum line connectable to a vacuum source, a vacuum valve controlling flow between the connecting line and the vacuum line, a pressure line connectable to a source of fluid under pressure, and a pressure valve controlling flow between the connecting line and the pressure line. A pressure manifold defines the pressure line and a first portion of the connection line, and supports the pressure valve, and a vacuum manifold defines the vacuum line and a second portion of the connecting line, and supports the vacuum valve. The vacuum manifold is adapted for replacement independently of the pressure manifold.

Among other aspects and advantages of the present disclosure, the pneumatic control system is adapted to protect the pressure manifold from contaminants ingested into the system through the vacuum line. In particular, the system includes a separate vacuum manifold that traps contaminants injected into the system and can be replaced independently of the pressure manifold. In this manner, only a portion of the pneumatic control system needs to be cleaned an/or replaced upon contaminants being ingested into the system through the vacuum line.

Additional aspects and advantages of the present disclosure will become readily apparent to those skilled in this art from the following detailed description, wherein exemplary embodiments of the present invention are shown and described, simply by way of illustration of the best modes contemplated for carrying out the present disclosure. As will be realized, the present disclosure is capable of other and different embodiments and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Reference is made to the attached drawings, wherein elements having the same reference characters represent like elements throughout, and wherein:

FIG. 1 is a partial cross-sectional elevation view of an example of a chemical-mechanical planarization (CMP) machine according to the prior art having a rotary union shown connected to an example of a pneumatic control system according to the prior art;

FIG. 2 is a schematic drawing of the pneumatic control system and the rotary union of FIG. 1;

FIG. 3 is a schematic drawing of an exemplary embodiment of a pneumatic control system including exemplary embodiments of vacuum manifolds constructed in accordance with the present invention and shown connected to a rotary union of a CMP machine;

FIG. 4A is a sectional view of another exemplary embodiment of a vacuum manifold constructed in accordance with the present invention;

FIG. 4B is a sectional view of another exemplary embodiment of a vacuum manifold constructed in accordance with the present invention;

FIG. 5 is a side perspective view showing a plurality of the vacuum manifolds of FIG. 4 arranged side-by-side;

FIG. 6 is a sectional view of an additional exemplary embodiment of a vacuum manifold constructed in accordance with the present invention;

FIG. 7 is a side elevation view showing a plurality of the vacuum manifolds of FIG. 6 arranged side-by-side and connected between a rotary union of a CMP machine and a vacuum trap;

FIG. 8 is a side elevation view showing a vacuum manifold connected to a rotary union of a CMP machine and secured together with brackets;

FIG. 9 is a side perspective view of an exemplary embodiment of a pneumatic control system constructed in accordance with the present invention and including further exemplary embodiments of a vacuum manifold constructed in accordance with the present invention;

FIG. 10 is a schematic drawing of an additional exemplary embodiment of a pneumatic control system constructed in accordance with the present invention and shown connected to a rotary union of a CMP machine;

FIG. 11 is a front perspective view of a further exemplary embodiment of a vacuum manifold constructed in accordance with the present invention;

FIG. 12 is a rear perspective view of the vacuum manifold of FIG. 11 shown connected to an exemplary embodiment of a pressure manifold constructed in accordance with the present invention; and

FIG. 13 is a front perspective view of the vacuum manifold and the pressure manifold of FIG. 12.

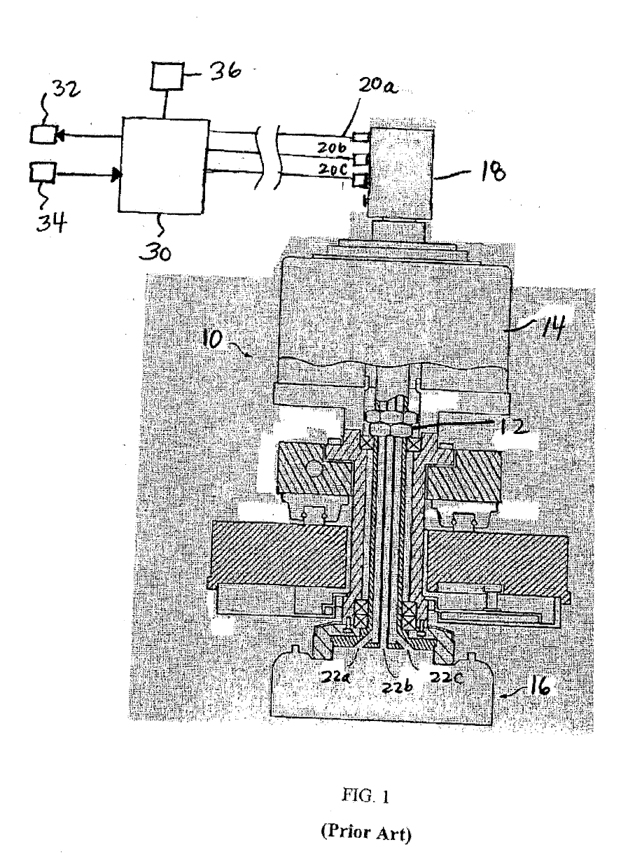

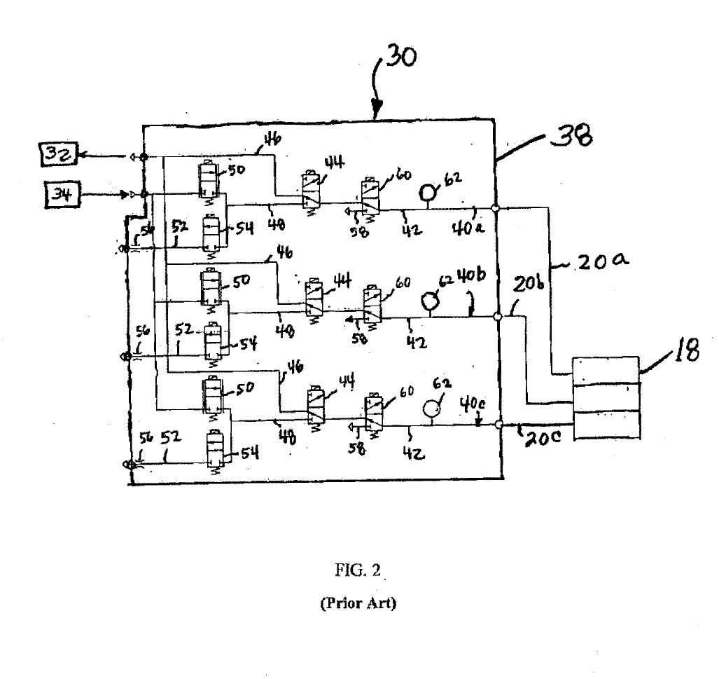

### DETAILED DESCRIPTION OF EXEMPLARY EMBODIMENTS

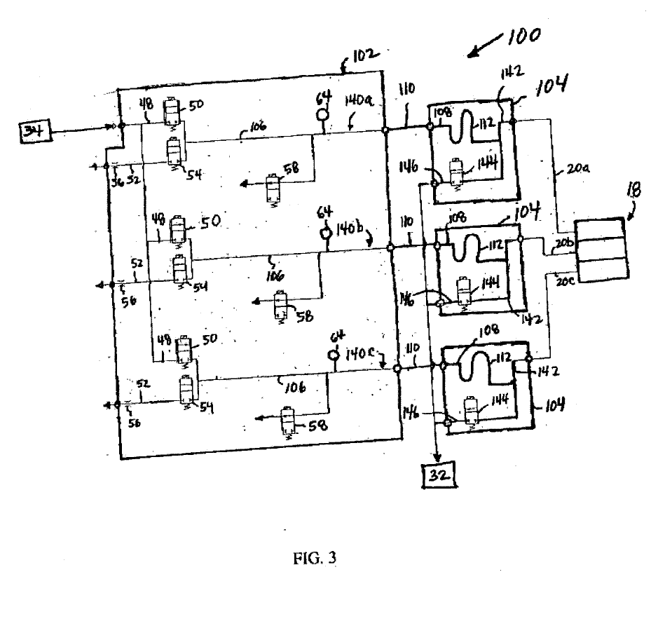

FIG. 3 is a schematic drawing of an exemplary embodiment of a pneumatic control system 100 constructed in accordance with the present invention and shown connected to a rotary union 18 of a CMP machine. However, it should be understood that the present invention is directed to the pneumatic control system 100 and not to a CMP machine, and it is intended that the pneumatic control system 100 of the present invention can be used with pneumatically-operated machines other than a CMP machine.

The pneumatic control system 100 includes a pressure manifold 102 defining pressure lines 48 of a plurality of flow control lines 140a-140c of the system 100. The pneumatic control system 100 also includes a plurality of vacuum manifolds 104, wherein each vacuum manifold 104 defines a vacuum line 146 of each of the flow control lines 140a-140c. The vacuum manifolds 104 are each adapted for replacement independently of the pressure manifold 102, and can be independent of the other vacuum manifolds 104.

Among other aspects and advantages of the present disclosure, the pneumatic control system 100 is adapted to protect the pressure manifold 102 from contaminants ingested into the system 100 through the vacuum lines 146. In particular, the system 100 includes the separate vacuum manifolds 104 that each traps contaminants injected into the system 100 and can be replaced independently of the pressure manifold 102. In this manner, only a portion of the pneumatic control system 100 needs to be cleaned an/or replaced upon contaminants being ingested into the system 100 through one of the vacuum lines 146 and the portion to be replaced does not carry the sensitive pressure transducer 62 and the pressure valve 50.

In the exemplary embodiment of FIG. 3, the pressure manifold 102 defines first portions 106 of the connecting lines 142 of the flow control lines 140a-140c, while each vacuum manifold 104 defines a second portion 108 of the connecting lines 142 of the flow control lines 140a-140c. Each of the connecting lines 142 also includes an intermediate portion 110 connecting the first portion 106 and the second portion 108. The intermediate portions 110 can comprise pipes or tubes connected between the pressure manifold 102 and the vacuum manifolds 104.

Each of the vacuum manifolds 104 supports a vacuum valve 144 controlling flow between the connecting lines 142 and the vacuum lines 146. All of the vacuum lines 146 merge and are connected to a single vacuum source 32.

Each of the vacuum manifolds 104 defines a liquid/solid trap 112 in the second portions 108 of the connecting lines 142. The liquid/solid traps 112 further ensure that solid or liquid contaminants ingested by the vacuum lines 146 do not enter the pressure manifold 102. In the exemplary embodiment shown, the liquid/solid traps comprise J-type traps 112. Alternatively, the liquid/solid traps can be provided in other configurations, such as J/D-type traps, or liquid filters.

The vacuum manifolds 104 have bodies that can be made from a suitably rigid, light-weight and durable material, such as aluminum or a plastic. If made of plastic, such as acrylic, the vacuum manifolds 104 can be made of a transparent plastic so that blockages within the liquid/solid traps 112 can be determined visually or can be determined using a light sensor.

In the exemplary embodiment of FIG. 3, the pressure manifold 102 supports the pressure valves 50 for all of the flow control lines, defines the bleed lines 52, and supports the bleed valves 54 and the vent valves 58. The pressure manifold 102 also defines the flow restrictors 56 in the bleed lines 52.

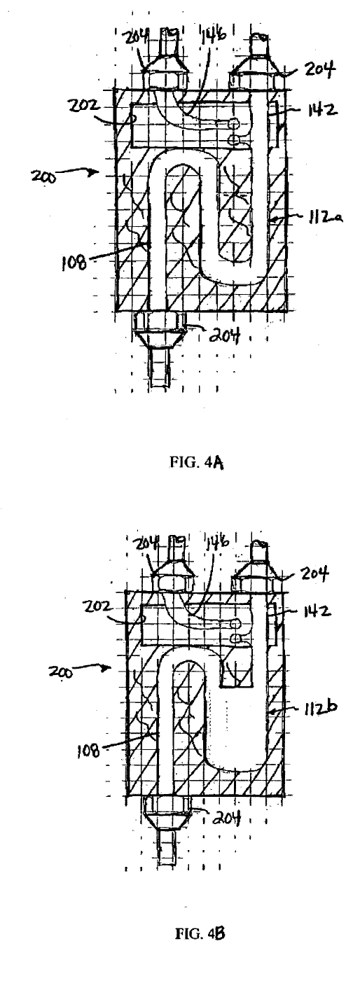

FIG. 4A is a sectional view of another exemplary embodiment of a vacuum manifold 200 constructed in accordance with the present invention. The vacuum manifold 200 of FIG. 4A is similar to the vacuum manifolds 104 of FIG. 3, so that similar elements share the same reference characters. The vacuum manifold 200 of FIG. 4A further includes a recess 202 for receiving the vacuum valve 202 (shown in outline) for controlling flow between the connecting line 142 and the vacuum line 146. The manifold 200 also includes external connectors 204, such as nipples having screw threads, for the connecting line 142 and the vacuum line 146.

The vacuum manifold 200 of FIG. 4B is almost identical to the vacuum manifold 200 of FIG. 4A. However, the vacuum manifold 200 of FIG. 4A includes a J-type trap 112a, while the vacuum manifold 200 of FIG. 4B includes a J/D-type trap 112b.

In the exemplary embodiment of FIG. 4, the vacuum manifold 200 includes a body that is made of transparent plastic so that blockages within the liquid/solid trap 112 can be determined visually or can be determined using a light sensor. In FIG. 5 a plurality of the vacuum manifolds 200 of FIG. 4 are arranged side-by-side so that, if desired, a single light source (illustrated by “A”) can be placed on one side of the manifolds 200 and a single light detector (illustrated by “B”) can be placed on the other side of the manifolds. Then a beam of light can be directed from the light source through all of the vacuum manifolds 200, and the single light sensor can detect the light passing through all of the vacuum manifolds. A blockage in the liquid/solid trap 112 of at least one of the vacuum manifolds 200 would be indicated upon the beam of light not being detected by the light sensor.

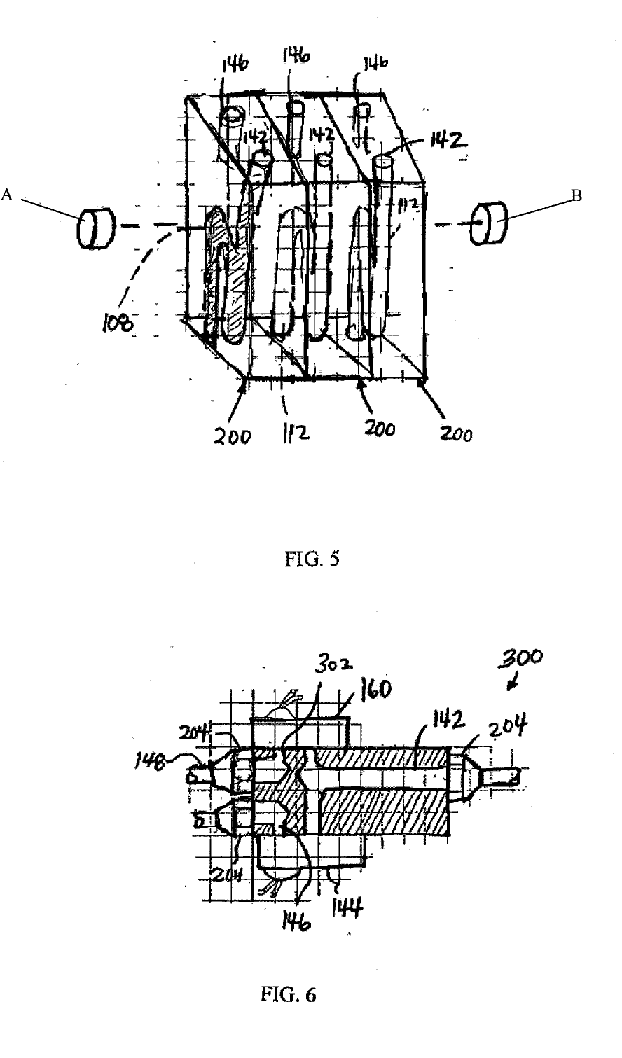

FIG. 6 is an additional exemplary embodiment of a vacuum manifold 300 constructed in accordance with the present invention. The vacuum manifold 300 of FIG. 6 defines the entire connecting line 142, and a portion 302 of a pressure line 148 and the vacuum line 146. In addition to supporting the vacuum valve 144 for controlling flow between the connecting line 142 and the vacuum line 146, the vacuum manifold 300 also supports a primary pressure valve 160 controlling flow between the connecting line 142 and the portion 302 of the pressure line 148. The primary pressure valve 160 is provided in addition to the pressure valves 50 supported in the pressure manifold 102, as shown in FIG. 3.

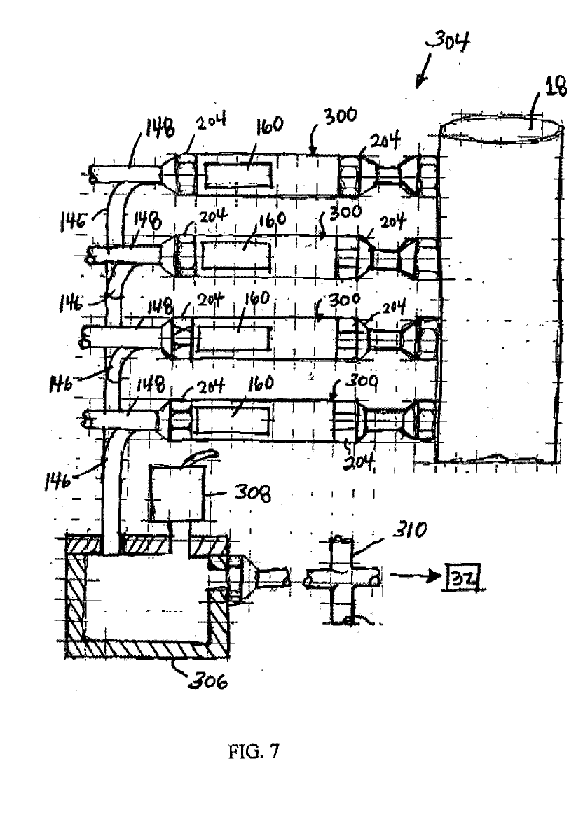

FIG. 7 shows an exemplary embodiment of an assembly 304 including a plurality of the vacuum manifolds 300 of FIG. 6 arranged side-by-side and connected to a rotary union 18 of a CMP machine. Although not shown, the pressure lines 148 extending from the vacuum manifolds 300 are connected to a pressure manifold, such as the pressure manifold 102 of FIG. 3. The vacuum lines 146 all connect to a single liquid/solid trap 306, which in turn is connected to the vacuum source 32. The liquid/solid trap 306 simply comprises a container which allows solids and liquids to fall to, and be collected in, a bottom of the trap 306 under the force of gravity, while gas can continue on into the vacuum source 32. A pressure transducer 308 may be connected to the liquid/solid trap 306 to monitor the vacuum level in the trap 306. As shown, a fitting 310 may be included between the liquid/solid trap 306 and the vacuum source 32 for connected other lines (e.g., the vent lines of the pressure manifold) to the vacuum source 32.

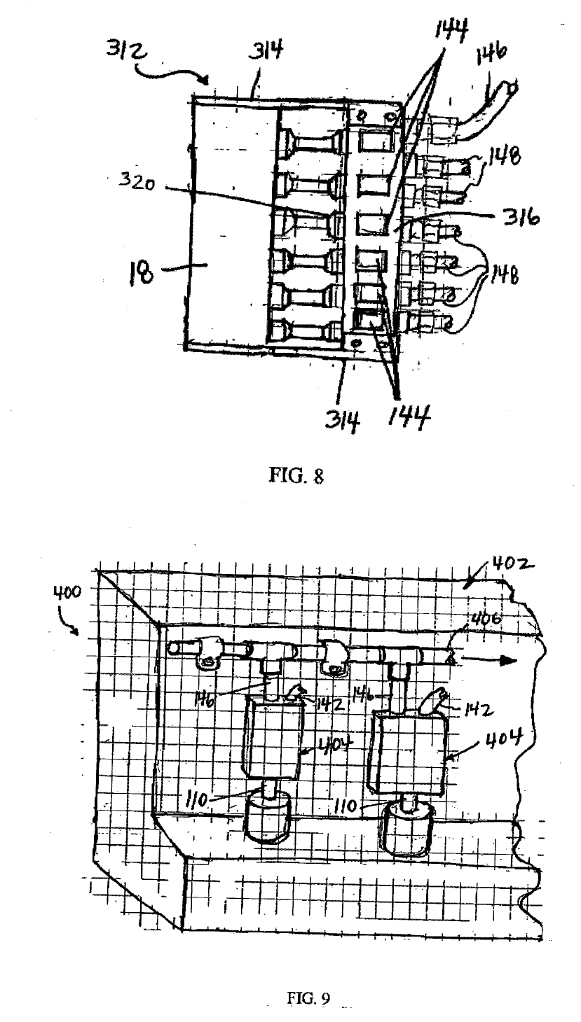

FIG. 8 shows another exemplary embodiment of an assembly 312 including a single vacuum manifold 320 connected to a rotary union 18 of a CMP machine. The assembly 312 also includes various brackets 314, 316 further securing the vacuum manifolds 300 to the rotary union 18 and securing the manifolds 300 to each other.

FIG. 9 shows a further exemplary embodiment of a pneumatic control system 400 constructed in accordance with the present invention and including further exemplary embodiments of a pressure manifold 402 and vacuum manifolds 404 constructed in accordance with the present invention. The system 400 of FIG. 9 is similar to the system 100 of FIG. 3. However, the vacuum manifolds 404 of FIG. 9 are of the type shown in FIG. 4A and are mounted on a shelf of the pressure manifold 402 and include connecting lines 142 and connected pressure lines 110 of the pressure manifold 402 and a rotary union (not shown) of a CMP machine. The vacuum manifolds 404 also have vacuum lines 146 connected to a system vacuum line 406, which is connected to a vacuum source (not shown). Although not shown, each vacuum manifold 404 contains a vacuum valve controlling flow between the connecting lines 142 and the vacuum lines 146. Each vacuum manifold 404 can also include a liquid/solid trap in the connecting line.

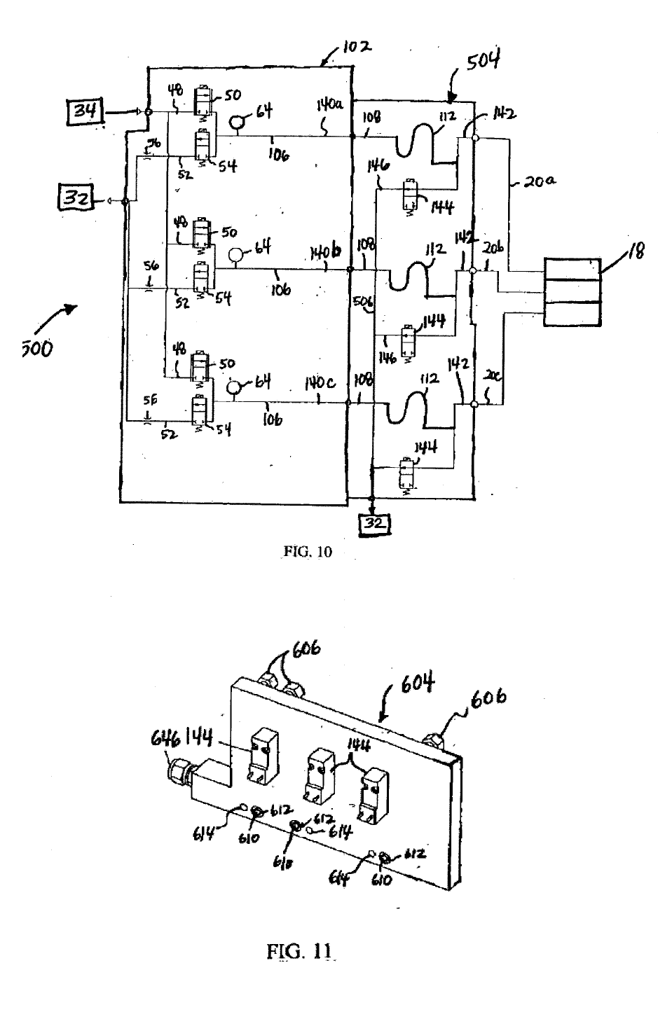

FIG. 10 shows an additional exemplary embodiment of a pneumatic control system 500 constructed in accordance with the present invention and shown connected to a rotary union 18 of a CMP machine. The system 500 of FIG. 10 is similar to the system 100 of FIG. 3, such that similar elements have the same reference characters. The system 500 of FIG. 10, however, includes a single vacuum manifold 504 that defines the vacuum lines 146 and supports the vacuum valves 144 for all of the flow control lines 140a-140c. The single vacuum manifold 504 also defines the liquid/solid traps 112 for each of the flow control lines 140a-140c. The pressure manifold 102 defines extensions 506 for the vacuum lines 146.

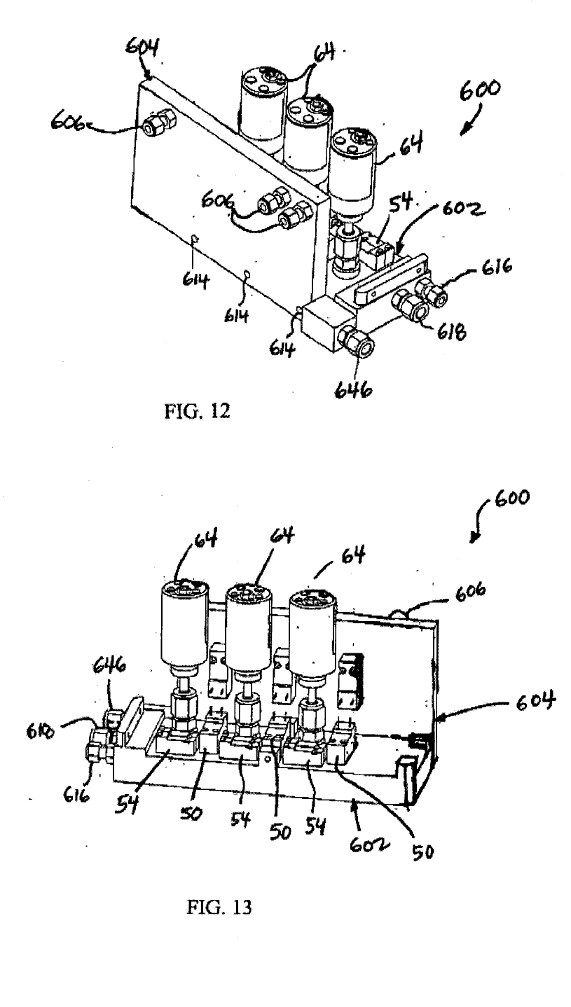

FIG. 11 shows still another exemplary embodiment of a vacuum manifold 604 constructed in accordance with the present invention. The vacuum manifold 604 of FIG. 11 is similar to the vacuum manifold 504 of FIG. 10, such that similar elements have the same reference characters. The vacuum manifold 604 of FIG. 11 includes a body made of a suitably rigid, light-weight and durable material, such as aluminum or a plastic. If made of plastic, the vacuum manifold 604 can be made of a transparent plastic so that blockages within the liquid/solid traps (not viewable) of the manifold 604 can be determined visually or can be determined using a light sensor. The vacuum manifold 604 includes three external connectors 606 for connecting the internal connecting lines (not viewable) of the manifold 604 to a pneumatically powered machine, such as an CMP machine (not shown). Another external connector 646 connects the internal vacuum lines (not viewable) to a vacuum source (not shown). The manifold 604 also includes openings 610 for connecting the internal connecting lines to pressure lines of a pressure manifold 602, as shown in FIGS. 12 and 13. The openings 610 are each surrounded with recesses 612 for receiving o-rings for providing a seal between the vacuum manifold 604 and the pressure manifold 602. Bolt holes 614 are provided next to each of the openings 610 and extend through the manifold 604 for securing the vacuum manifold 604 to the pressure manifold 602. The manifold 604 also includes the vacuum valves 144 for controlling flow between the connecting lines and the vacuum lines.

In FIG. 12 the vacuum manifold 604 of FIG. 11 is shown connected to an exemplary embodiment of a pressure manifold 602 constructed in accordance with the present invention to form a pneumatic control system 600 according to the present invention. The pressure manifold 602 includes an external connector 616 for connecting the internal pressure lines (not viewable) to a pressure source, and an external connector 618 for connecting the internal vent lines (not viewable) to a vacuum source. Pressure transducers 64 are mounted to the manifold 602 and are in fluid communication with the internal pressure lines, while pressure valves 50 control flow between the vacuum manifold 604 and the internal pressure lines, and bleed valves 54 control flow between the internal pressure lines and the internal vent lines.

The present invention, therefore, provides pneumatic control systems that are adapted to protect pressure manifolds from contaminants ingested into the system through vacuum lines. In particular, the systems include separate vacuum manifolds that trap contaminants injected into the systems and can be replaced independently of the pressure manifolds. In this manner, only a portion of the pneumatic control systems needs to be cleaned an/or replaced upon contaminants being ingested into the systems through the vacuum lines.

The exemplary embodiments described in this specification have been presented by way of illustration rather than limitation, and various modifications, combinations and substitutions may be effected by those skilled in the art without departure either in spirit or scope from this disclosure in its broader aspects and as set forth in the appended claims.

What is claimed is:

1. A pneumatic control system comprising:
at least one flow control line including,
a connecting line connectable to a fluid line of a pneumatically operated machine,
a vacuum line connected to the connecting line and connectable to a vacuum source,
a vacuum valve controlling flow through the vacuum line,
a pressure line connected to the connecting line and connectable to a source of fluid under pressure, and
a pressure valve controlling flow through the pressure line;
a pressure manifold defining at least a portion of the pressure line and supporting the pressure valve; and
a vacuum manifold defining at least a portion of the vacuum line and supporting the vacuum valve, wherein the vacuum manifold is adapted for replacement independently of the pressure manifold.

2. A system according to claim 1, wherein the connecting line of the flow control line includes a liquid/solid trap.

3. A system according to claim 2, wherein the liquid/solid trap comprises a J-type trap.

4. A system according to claim 2, wherein the liquid/solid trap comprises a J/D-type trap.

5. A system according to claim 2, wherein the liquid/solid trap is defined by the vacuum manifold.

6. A system according to claim 1, comprising a plurality of the flow control lines.

7. A system according to claim 6, wherein the pressure manifold defines at least a portion of the pressure line and supports the pressure valve for all of the flow control lines.

8. A system according to claim 6, wherein the vacuum manifold defines at least a portion of the vacuum line and supports the vacuum valve for all of the flow control lines.

9. A system according to claim 6, wherein each of the flow control lines includes one of the vacuum manifolds, and wherein each of the vacuum manifolds is adapted for replacement independently of the other of the vacuum manifolds.

10. A system according to claim 9, wherein each of the vacuum manifolds is transparent.

11. A system according to claim 10, wherein the vacuum manifolds are arranged in a row.

12. A system according to claim 6, wherein the vacuum manifolds are secured together with brackets.

13. A system according to claim 1, wherein the flow control line further includes a primary pressure valve connecting the connecting line and the pressure line, and wherein the vacuum manifold supports the primary pressure valve.

14. A system according to claim 1, wherein the vacuum line of the flow control line includes a liquid/solid trap.

15. A system according to claim 1, wherein the flow control line further includes a vent line connected to one of the connecting line and the pressure line, and a vent valve controlling flow through the vent line.

16. A system according to claim 15, wherein the pressure manifold defines the vent line and supports the vent valve.

17. A system according to claim 15, wherein the vent line includes a flow restrictor.

18. A system according to claim 1, further comprising a computer controlling the pressure valve and the vacuum valve.

19. A system according to claim 1, wherein the flow control line further includes a pressure transducer in the pressure line.

20. A CMP carrier head system including a pneumatic control system according to claim 1, and further including:
a carrier head including at least one expandable bladder defining at least one internal chamber within the carrier head; and
a rotary coupling defining a fluid line connected to the internal chamber of the carrier head, wherein the flow control line of the pneumatic control system is connected to the fluid line of the rotary coupling.

21. A system according to claim 1, further comprising a vacuum source connected to the vacuum line and a pressure source connected to the pressure line.

22. A method for protecting a pressure line of a pneumatic control system from contaminants ingested by a vacuum line of the pneumatic control system, comprising:
providing a pressure manifold defining at least a portion of the pressure line; and
providing a vacuum manifold defining at least a portion of the vacuum line, wherein the vacuum manifold is adapted for replacement independently of the pressure manifold.

23. A method according to claim 22, further comprising providing a liquid/solid trap between the pressure manifold and the vacuum manifold.

24. A method according to claim 23, wherein the liquid/solid trap is defined by the vacuum manifold.

25. A method according to claim 22, wherein the pneumatic control system includes a plurality of the flow control lines and the vacuum manifold defines at least a portion of the vacuum line for all of the flow control lines.

26. A method according to claim 22, wherein the pneumatic control system includes a plurality of the flow control lines, and a plurality of the vacuum manifolds are provided and each of the vacuum manifolds defines at least a portion of the vacuum line for one of the flow control lines.
